(19) United States
(12) Patent Application Publication
(10) Pub. No.: US 2006/0008098 A1
(43) Pub. Date: Jan. 12, 2006

(54) Single crystal silicon micromachined capacitive microphone

(76) Inventor: Xiang Zheng Tu, Redwood City, CA (US)

Correspondence Address: Bruce H. Johnsonbaugh;Eckhoff & Hoppe, 333 Sacramento Street, San Francisco, CA, 94111, US

(21) Appl. No.: 10/886,472

(22) Filed: Jul. 7, 2004

(51) Int. Cl. H04R 25/00; H04R 9/08; H04R 11/04

(52) U.S. Cl. 381/175; 381/369; 381/174

(57) ABSTRACT

A single crystal silicon micromachined capacitive microphone is disclosed. The microphone comprises a flexible plate made from a bottom layer of a first epitaxial single crystal silicon layer, a stiff and perforated plate made from a portion of a second epitaxial single crystal silicon layer, a supporting frame is made from a combination of lateral overgrowth of the first epitaxial single crystal silicon layer and a polysilicon layer grown or deposited on the surface of an insulating layer, and an air gap is formed by etching a portion of the first epitaxial single crystal silicon layer. Both the first epitaxial single crystal silicon layer and the second epitaxial single crystal silicon layer are developed from a single crystal silicon substrate. A micromaching technology based on selective formation and etching of porous single crystal silicon layers is used to make the microphone structure.

### FIELD OF THE INVENTION

This invention relates generally to a micromachined capacitive microphone and method and more particularly to a single crystal silicon micromachined microphone in which the capacitive elements are all made up of two epitaxial single crystal silicon layers developed from a single crystal silicon substrate.

### BACKGROUND OF THE INVENTION

Microphones or acoustic transducers are widely employed in a variety of consumer products and specialty instruments such as telephone sets, tape-recorders, video cameras, speech amplifiers and hearing aids. Silicon micro-electro-mechanical-system (MEMS) technology has been used to produce a variety of microphones, which are based on the principle of a variable capacitance, where one electrode of the capacitor is on a flexible plate and moves in response to an acoustic signal.

A good microphone has several qualities: (I) capable of being processed directly to a PCB using standard automatic pick-and-place equipment, and surface mounted via standard solder reflow equipment, (II) a very high degree of control of dimensions, (III) miniaturization of the devices and mechanical elements, (IV) capable of batch fabrication and hence the subsequent reduction of cost from economies of scale, and (V) integration of the acoustic transducers with integrated circuits e.g. CMOS to make a system-on-a-chip; (VI) all of these factors help in improving the cost-performance product for these acoustic devices.

Many efforts have been made to fabricate acoustic capacitive microphones. W. Kuhnel et al. have reported a micromachined subminiature capacitive microphone [W. Kuhnel, and G. Hess, “Micro-machined subminiature condenser microphones in silicon,” Sensors and Actuators A, 32 (1992), 560-564]. The described capacitive microphone consists of a membrane chip and a back plate chip. The membrane chip has a silicon nitride thickness of 150 nm and a metallization layer thickness of 100 nm. The back plate chip has an electrode on a silicon bridge. Both the chips are fabricated respectively and then bonded together to form a capacitor.

J. J. Bernstein et al. have reported the fabrication and results of very high sensitivity acoustic transducers fabricated using surface and bulk silicon micro-machining techniques in a manufacturing environment [A. E. Kabir, R. Bashir, J. Bernstein, J. De Santis, R. Mathews, J. 0. O'Boyle, C. Bracken, “Very High Sensitivity Acoustic Transducers with Thin P+ Membrane and Gold Back Plate”, Sensors and Actuators-A, Vol. 78, issue 2-3, pp. 138-142, 17th Dec. 1999]. The silicon microphone described here is a capacitive microphone. The basic movable element is a thin (˜3 micron thick) diaphragm made from p+ silicon. The p+ silicon is one side of an air gap capacitor. The p+ regions are formed using boron solid source diffusion at high temperatures. The other plate of the capacitor is a 20 micron thick perforated gold back plate formed using electroplating. The air gap is defined using a 2.2 micron thick sacrificial photoresist.

A U.S. Pat. No. 5,490,220 disclosed a solid state capacitive microphone device with good sensitivity. The device comprises a back plate formed from a silicon wafer, a diaphragm formed from a thinner silicon nitride layer, and a keeper formed from a thicker silicon nitride layer.

Altti Torkkeli et al. have reported a capacitve silicon microphone [Altti Torkkeli, Jaakko Saarilahti, Heikki Sepp, Hannu Sipola, Outi Rusanen, and Jarmo Hietanen, Capacitive Silicon Microphone Physica Scripta Online Vol. T79, 275-278, 1999]. The reported capacitive silicon microphone consists of two freestanding polysilicon membranes, a low-stress bending membrane and a high-stress backplate, which are separated by an air gap. A backchamber is arranged by encapsulation and static pressure changes are prevented with small equalization holes in the bending membrane. The device is fabricated combining bulk and surface micromachining techniques. Silicon substrates are etched in TMAH and sacrificial oxide between the membranes is etched in PSG-etch followed by freeze drying to prevent sticking.

The microphone design has gone through a number of iterations since the fabrication of the first batch of working devices. The most notable efforts have been made to reduce the thickness of the flexible plate and the air gap and lower the bias voltage of the capacitor.

However, it should be pointed out that difficulties have frequently been encountered with such efforts. In a thin plate there are two kinds of forces which resist deflection in response to acoustic signals. The first kind of force includes plate bending forces which are proportional to the thickness of the plate. These forces can be reduced by using a very thin plate. The second kind of force, which resists deflection, includes membrane forces which are proportional to the tension applied to the plate. In the case of a thin plate, tension is generally a result of the fabrication technique and of mismatches in thermal expansion coefficients between the plate and the particular means utilized to hold the plate in place. The thermal mismatched tension lowers the flatness of the plate. Reducing the thickness of the plate and air gap may mean the capacitor plates pulling together under a lower bias voltage.

### OBJECT OF THE INVENTION

An important object of the present invention is therefore to improve upon the above-noted prior art technology, by providing a single crystal micromachined capacitive microphone whose capacitive elements are made up of two epitaxial single crystal silicon layers so as to cancel all thermal mismatched tension related problems forever.

A further object of the present invention is to provide a single crystal micromachined capacitive microphone having a flexible plate whose tension can be precisely defined by adjusting the doping concentration thereof.

Another object of the present invention is to provide a single crystal micromachined capacitive microphone whose lateral length shrinkage is not limited by the open area of the acoustic cavity.

Still another object of the present invention is to provide a single crystal micromachined capacitive microphone whose flexible plate thickness can be controlled precisely and easily reduced down to 0.5 micron.

Still another object of the invention is to provide a single crystal micromachined capacitive microphone whose air gap thickness and lateral length can be controlled precisely and easily reduced down to 2 micron and 1 mm, respectively.

Still another object of the invention is to provide a single crystal micromachined capacitive microphone having an integrated CMOS circuit made up of the same epitaxial single crystal silicon layer with the microphone.

A general object of the invention is to provide a single crystal micromachined capacitive microphone whose performance can be improved and the production cost can be reduced.

### SUMMARY OF THE INVENTION

According to the present invention, there is disclosed a single crystal silicon micromachined capacitive microphone whose capacitor structure comprises a single crystal silicon substrate, an acoustic cavity recessed from the back side of the substrate, a flexible single crystal silicon plate with the edge clamped to the inside of the substrate and the rear side facing the cavity, a single crystal silicon contained supporting frame having the top surface coated with a thin insulating layer, a stiff and perforated single crystal silicon plate supported at the edge by the supporting frame, an air gap sandwiched by the flexible plate and the stiff plate and surrounded by the supporting frame, and two electrodes disposed around the stiff and perforated plate and interconnecting to the flexible plate and the stiff and perforated plate, respectively.

The flexible plate is made from a 0.5 to 2 micron thick bottom remained layer of a first epitaxial single crystal silicon layer. In order to produce the thinner remained layer from the thicker first epitaxial single crystal silicon layer, a 2 to 4 micron thick second porous single crystal silicon well is created into the top layer of the first epitaxial single crystal silicon layer by anodization in HF solution. Since porous silicon is preferably formed in a heavily doped P-type region rather than in a lightly doped P-type region or heavily doped N-type region than a lightly doped N-type region, the second porous single crystal silicon well can be controlled to be thinner than the first epitaxial single crystal silicon layer by forming a doped layer with a thickness less than the thickness of the first epitaxial single crystal layer. After selective etching of the second porous silicon well, the thinner remained layer of the first epitaxial single crystal silicon layer takes place. To release the thinner remained layer, the first epitaxial single crystal silicon layer is grown on a first porous single crystal silicon well, which is created into the single crystal silicon substrate by anodization in HF solution. After selective etching of the first porous single crystal silicon well, the thinner remained layer is suspended and becomes the flexible plate.

The stiff and perforated plate is made from a portion of a 10 to 20 micron thick second epitaxial single crystal silicon layer, which is grown on the surface of the second porous single crystal silicon well. The supporting frame is made from a portion of the first epitaxial single crystal silicon layer, which encloses the second porous single crystal silicon well. Etching of the second porous single crystal silicon well leads to form the 10 to 20 micron thick stiff and perforated plate, supporting frame, and 2 to 4 micron thick air gap at the same time.

Since the top of the supporting frame is coated with a thin insulating layer, the stiff and perforated plate can be electrically insulated from the flexible plate. Actually, the single crystal silicon substrate has a patterned insulating layer on its front surface, during the process for forming the second epitaxial single crystal silicon layer a polysilicon layer is also deposited on the surface of the insulating layer at the same time. The epitaxial single crystal silicon layer includes three portions. The first portion is grown on the surface of the second porous single crystal silicon well. The second portion is grown on the surface of the rest of the first epitaxial single crystal silicon layer, which does not cover with the insulating layer and the second porous single crystal silicon well. The third portion is grown on the edge surface of the insulating layer, which is called lateral overgrowth of the epitaxial single crystal silicon layer. The polysilicon layer is only deposited on the surface of the central region of the insulating layer. Both the lateral overgrowth of single crystal silicon layer and the deposited polysilicon layer emerge together and clamp the stiff and perforated plate therein.

Two deep trenches separate the two electrodes each other and with the rest of the second epitaxial single crystal silicon layer. One deep trench surrounding an electrode is placed on the surface of the emerged region of the lateral overgrowth of the second epitaxial single crystal silicon layer and the deposited polysilicon layer so that it is only allowed to electrically interconnect to the stiff and perforated plate. The other deep trench surrounding the other electrode placed on the surface of a portion of the second epitaxial single crystal silicon layer so that it is only allowed to electrically interconnect to the flexible plate.

Selective etching of porous single crystal silicon can be done by using a 1 to 5% KOH solution at room temperature or a 49% HF:30% H₂O₂ (1:5) solution at room temperature. These two kinds of solutions only attack porous single crystal silicon, but not non-porous single crystal silicon or single crystal silicon.

### BRIEF DESCRIPTION OF THE DRAWINGS

FIG. 1 is a cross-sectional view of a prior art micromachined capacitive microphone.

FIG. 2 is a partly cut-off schematic perspective view of a single crystal silicon micromachined capacitive microphone introduced by the present invention.

FIG. 3 is a cross-sectional view of the single crystal silicon micromachined capacitive microphone at the first fabrication step, which shows a first porous single crystal silicon well formed in a single crystal silicon substrate.

FIG. 4 is a cross-sectional view of the single crystal silicon micromachined capacitive microphone at the second fabrication step, which shows a first epitaxial single crystal silicon layer grown over the surface of the single crystal silicon substrate including the surface of the first porous single crystal silicon well.

FIG. 5 is a cross-sectional view of the single crystal silicon micromachined capacitive microphone at the third fabrication step, which shows a second porous single crystal silicon well formed in the first epitaxial single crystal silicon layer.

FIG. 6 is a cross-sectional view of the single crystal silicon micromachined capacitive microphone at the fourth fabrication step, which shows a second epitaxial single crystal silicon layer that includes a first portion grown on the surface of the second porous single crystal silicon well, a second portion directly grown on the surface of the first epitaxial single crystal silicon layer, and a third portion being a lateral overgrowth of the epitaxial single crystal silicon layer grown on the edge surface of an insulating layer, and a polysilicon layer deposited on the surface of the central region of the insulating layer.

FIG. 7 is a cross-sectional view of the single crystal silicon micromachined capacitive microphone at the fifth fabrication step, which shows a stiff and perforated plate formed by making throughout holes in a portion of the second epitaxial single crystal silicon layer, which is located above the second porous single crystal silicon well and etching away the second porous silicon well through the throughout holes.

FIG. 8 is a cross-sectional view of the single crystal silicon micromachined capacitive microphone at the sixth fabrication step, which shows two electrodes formed so as to electrically interconnect to the stiff and perforated plate and the first epitaxial single crystal silicon layer, respectively.

FIG. 9 is a cross-sectional view of the single crystal silicon micromachined capacitive microphone at the seventh fabrication step, which shows an acoustic cavity created on the back side of the single crystal silicon substrate, which has a remained layer of the single crystal silicon substrate on the bottom thereof.

FIG. 10 is a cross-sectional view of the single crystal silicon micromachined capacitive microphone at the eighth fabrication step, which shows a laterally expanded cavity and a flexible plate formed by etching away the remained layer of the single crystal silicon substrate and the first porous single crystal silicon well.

FIG. 11 is a cross-sectional view of the single crystal silicon micromachined capacitive microphone at an additional fabrication step, which shows a CMOS circuit formed in a portion of the second epitaxial single crystal silicon layer.

### DETAILED DISCRIPTION OF THE INVENTION

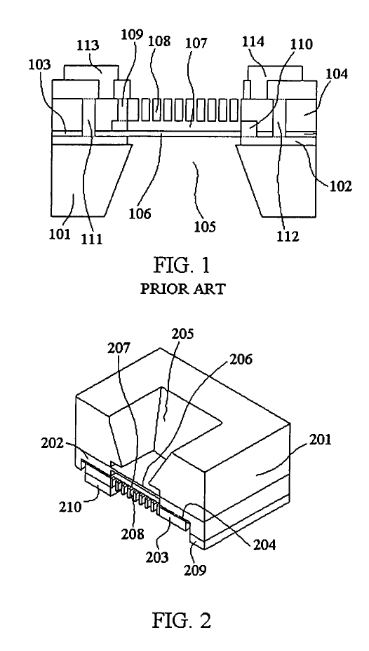

A typical prior art micromachined capacitive microphone, as shown in FIG. 1, comprises an acoustic cavity 105, a 1-3 μm thick flexible plate 106, a 3-5 μm thick air gap 107, a 10-20 μm thick stiff and perforated plate 108, a first insulating trench couple 109 and 110, a second insulating trench couple 111 and 112, and an electrode couple 113 and 114. The flexible plate 106, the stiff and perforated plate 108, and the air gap 107 form a parallel plate capacitor.

As can be seen from FIG. 1, the flexible plate 106 is made from a SOI (single crystal silicon on insulator) wafer, which consists of a thick single crystal silicon substrate 101, a thin insulation layer 102, and a thin single crystal silicon layer 103. To complete the capacitor, a polysilicon layer 104 and a sacrificial layer are added to the top of the SOI wafer. The stiff and perforated plate is made up of the polysilicon layer 104 and released by etching of a portion of the sacrificial layer. The remained portion of the sacrificial layer is used to form a supporting frame for clamping the perforated plate.

A single crystal silicon micromachined capacitive microphone introduced by the present invention, as shown in FIG. 2, comprises an acoustic cavity 205, a 0.5 to 2 micron thick flexible plate 206, a 2 to 4 micron thick air gap 207, a 10 to 20 micron thick stiff and perforated plate 208, and an electrode couple 209 and 210.

It can be seen from FIG. 2 that the starting wafer for making the microphone consists of a thick single crystal silicon substrate 201, a first epitaxial single crystal silicon layer 202, a second epitaxial single crystal silicon layer 203, and a 0.5 micron thick insulating layer 204. The flexible plate 206 is formed by thinning of the first epitaxial single crystal silicon layer 202. The stiff and perforated plate 208 is made from a portion of the second epitaxial single crystal silicon layer 203 and supported by a portion of the first epitaxial single crystal silicon layer 202, which is coated with the 0.5 micron thick insulating layer 204 thereon.

Compared with the prior art capacitive microphone, it is easy to find that the single crystal silicon micromachined capacitive microphone has several outstanding features.

Firstly, the single crystal silicon microphone is made from a three layer structure consisting of a single crystal silicon substrate, a thinner epitaxial single crystal silicon layer, and a thicker epitaxial single crystal layer and the prior art microphone is made from a five layer structure consisting of a single crystal silicon substrate, a thin insulating layer, a thin single crystal silicon layer, a thicker oxide layer, and a thicker polysilicon layer. The three layer structure of the single crystal silicon microphone is composed of a same kind of material. In this structure there is no thermal mismatched tension to reside therein. All thermal mismatched tension related problems are able to cancel forever.

The five layer structure of the prior art microphone is composed of three different kinds of materials. Due to having different thermal expansion coefficient, thermal mismatched tension always exists between each two different material layers. As is well known, lower tension may result in lowering the sensitivity of the devices and higher tension may result in damage of the devices. Furthermore, a released thin plate with a strong tension often bucks up so that the achievable thickness of the flexible plate and the air gap of the microphone are severely limited.

Secondly, the acoustic cavity of the all single crystal silicon microphone has an opening area smaller than the area of the flexible plate and the acoustic cavity of the prior art microphone has an opening area larger than the area of the flexible plate. A small opening area means less losing mechanical strength and enables to further shrink the microphone size.

Thirdly, the epitaxial single crystal silicon layer for making the stiff and perforated plate has a rest portion with high quality, which can be used to fabricate an electronic circuit, such as a CMOS circuit for conditioning the electronic signals generated by the microphone. For the prior art microphone the top layer is a polysilicon layer that cannot be used to fabricate the CMOS circuit.

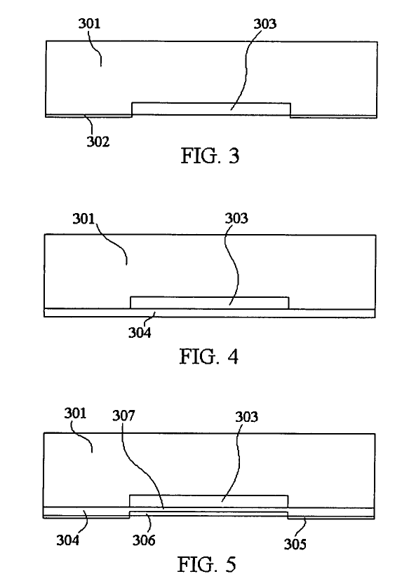

The process for fabricating the single crystal silicon micromachined capacitive microphone, in accordance with the present invention, as illustrated in FIG. 3 to FIG. 11, comprises eight major steps. The first step is shown in FIG. 3, which begins with a double side polished single crystal silicon substrate 301. The substrate 301 is not restricted but is preferable to be P-type doped and oriented in (100) crystallographic direction, and to have a typical resistivity ranging from 1 to 10Ω-cm. A 1 μm thick oxide layer 302 is first formed over the surface of the substrate 301 by using thermal oxidization. A first anodization area with a lateral length of 500 to 2000 microns is defined by using photoresist mask and dry/wet etching of oxide on the front side of the substrate 301. Then, thermal diffusion is carried out to form a 5 to 8 μm thick boron doped layer in the anodization area and the backside of the substrate 301. The resulted average concentration ranges from 10¹⁸ to 10¹⁹/cm³. If the substrate 301 has a doped concentration ranging from 10¹⁸ to 10¹⁹/cm³, the above mentioned diffusion process can be omitted.

After removing the remained oxide, a new 500 to 1000 Angstrom thick oxide layer is formed over the front side of the substrate 301 by using thermal oxidization. Then, a 2000-3000 Angstrom thick nitride layer is formed over the oxide layer by using low pressure chemical vapor deposition (LPCVD). The anodization area is revealed by using photoresist mask and dry/wet etching of oxide and nitride. Next, anodization is performed in a double electrochemical cell. A used etchant is a 49% HF:C₂H₅OH(2:1) solution at room temperature and a used anodic current ranges from 5 to 20 mA/cm². A resulted first porous single crystal silicon well 303, as indicated in FIG. 3, has a thickness ranging from 5 to 20 μm and a porosity ranging from 10 to 20%. The thickness of the first porous single crystal silicon well 303 can be larger than the thickness of the boron doped layer, because the anodization front may pass through the doped layer and go into the single crystal silicon substrate 301. The thickness of the first porous single crystal silicon well 303 can be controlled by counting the anodization time.

The following step initiates with slightly oxidizing the porous single crystal silicon well 303 in dry O₂ ambient at 300-400° C. for 1 h. This low temperature treatment is used to passivate the pore walls for suppressing structural change in the pore feature during the subsequent high temperature processes. After removing the thin oxide layer on the surface of the single crystal silicon substrate 301 by etching in diluted HF solution, an epitaxial single crystal silicon layer is grown over the front surface of the single crystal silicon substrate 301 in a chemical vapor deposition (CVD) epitaxial reactor with a mixture of SiH₂Cl₂ and H₂ at 950 to 1050° C. The resulted first epitaxial single crystal silicon layer 304 may be doped with boron and have a typical resistivity ranging from 1 to 10Ω-cm and a thickness ranging from 3 to 5 μm, as indicated in FIG. 4.

At the beginning of the third step, a new composite insulating layer of oxide and nitride is formed by using LPCVD with the same parameters as the above-mentioned similar oxide/nitride deposition process. Then, a second anodization area with a lateral length of 500 to 2000 microns is defined by using wet/dry etching of oxide and nitride, which results in creating a mask pattern 305. Next, thermal diffusion is carried out to form a 2 to 4 micron thick boron doped layer in the anodization area. The resulted average concentration ranges from 10¹⁸ to 10¹⁰/cm³. The thickness of the doped layer is controlled so as to remain a 0.5 to 2 micron thick undoped layer of the first epitaxial single crystal silicon layer 304. Anodization is performed under the same conditions as the above mentioned similar anodization process, which results in a 2 to 4 micron thick second porous single crystal silicon well 306 and a 0.5 to 2 micron thick thinned or remained layer 307 of the first epitaxial single crystal silicon layer 304, as indicated in FIG. 5.

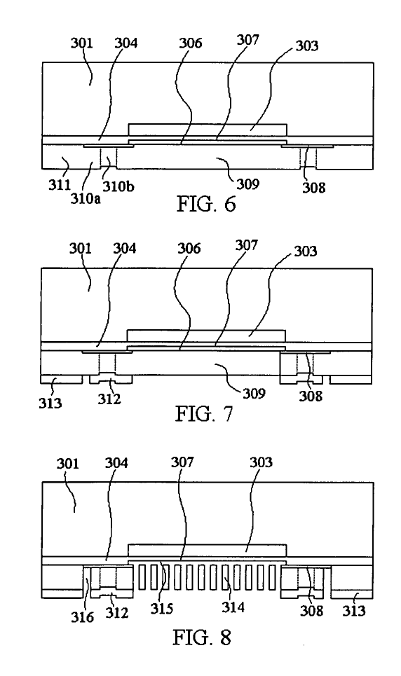

The fourth step involves in thermal treatment of the second porous single crystal silicon well 306, which is performed with the same conditions as the above mentioned similar process. Then, another insulating layer of oxide and nitride is formed by using LPCVD with the same parameters as the above-mentioned similar oxide/nitride deposition process. The insulating layer is patterned so as to form an oxide/nitride pattern 308 enclosing the anodization area. Next, a 10 to 20 micron thick second epitaxial single crystal silicon layer is grown over the surface of the first epitaxial single crystal silicon layer 304, including the surface of the second porous silicon well 306 with the same growth conditions as the above-mentioned similar epitaxial growth process. It should be noted that the second epitaxial single crystal silicon layer includes a portion 309 grown on the surface of the second porous single crystal silicon well, a portion 311 grown on the surface of the revealed first epitaxial single crystal silicon layer 304, and a portion 310a grown on the edge surface of the insulating pattern 308. The portion 310a is a lateral overgrowth of the second epitaxial single crystal silicon layer, which generally has the lateral length near the thickness of the second epitaxial single crystal silicon layer. It should be also noted that a polysilicon layer 310b is deposited on the surface of the central region of the insulating pattern 308 during the above mentioned epitaxial growth process. The thickness of the deposited polysilicon layer 310b is generally less than the thickness of the second epitaxial single crystal silicon layer. The cross sectional view of the second epitaxial single crystal silicon layer and the deposited polysilicon layer 310b are shown in FIG. 6.

In the fifth step, a metallization pattern is created on the surface of the second epitaxial single crystal silicon layer. As can be seen from FIG. 7, the pattern consists of electrodes 312 and 313. The electrode 312 is placed on the top surface of the insulating pattern 308. The electrode 313 is placed on the surface of the portion 311 of the second epitaxial single crystal silicon layer 304. The metal layer used to form the metallization pattern is proffered to be 3000 to 5000 micron thick gold layer or the like with a 500 to 1000 micron thick chrome layer as an adhesive layer.

As illustrated in FIG.8, the sixth step is to etch a plurality of throughout holes into the portion 309 of the second epitaxial single crystal silicon layer and then etch away the second porous single crystal silicon well 306, resulting in a 2 to 4 micron thick air gap 315 and a 10 to 20 micron thick stiff and perforated plates 314.

The etching of the throughout holes can be done using a deep reactive ion etcher (DRIE). The lateral length of the holes ranges from 20 to 80 μm and the distance between the two holes ranges from 30 to 100 μm. It should be noted that additional two deep trenches are created at the same time with the throughout holes formation. One deep trench indicated by 316 in FIG. 8 is used to electrically isolate the region from the other region of the second epitaxial single crystal silicon layer. The other deep trench is not indicated in FIG. 8, which is used to separate a region from the second epitaxial single crystal silicon layer for carrying the electrode 313 so as to electrically interconnect to the first epitaxial single crystal silicon layer 304.

Then, the second porous single crystal silicon well 306 is removed by selective etching, resulting in a 2 to 4 micron thick air gap 315, as shown in FIG. 8. The selective etching can be accomplished in two wet etch step process. The first wet etch is to remove oxide formed on the sidewalls of the pores by etching in a buffered HF solution. The second wet etch is to remove the porous silicon by immersing in a diluted HF solution and then in a 1 to 5% KOH solution. It should be noted that before etching in a 1 to 5% KOH solution, it is necessary to immerse in a diluted HF solution for a few minutes to remove the thin oxide on the wells of the pores.

Alternatively, the porous single crystal silicon well 306 is removed by etching in a 49% HF:30% H₂O₂ (1:5) solution. During this etching process, the solution penetrates into the pores of the porous silicon layer by capillarity, and then etches the walls of the pores in sideways direction. Eventually, the porous structure can no longer support itself and collapses. It should be noted that 49% HF:30% H₂O₂(1:5) solution does not attack single crystal silicon at all.

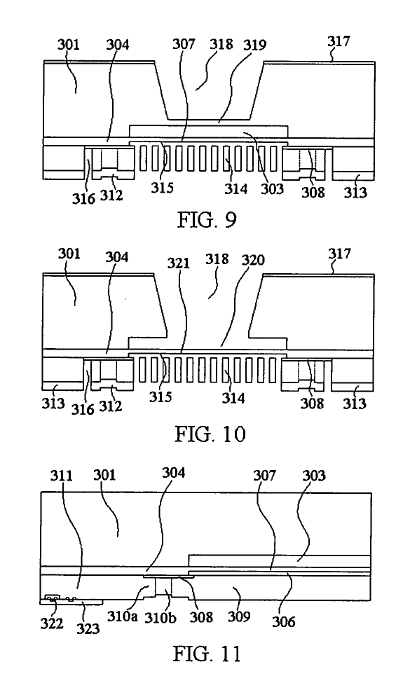

As illustrated in FIG. 9, the seventh step is to create an acoustic cavity 318 from the backside of the single crystal silicon substrate 301. To do this, a 2000 to 3000 Å thick LPCVD nitride layer is formed on the back side of the single crystal silicon substrate 301 and then a nitride pattern 317 is defined by using photoresist mask and dry etching of nitride. Using the nitride pattern 317 as protecting mask, wet etching is performed. A used etchant is 50% KOH in water at 50° C., resulting in an etch rate of about 1 μm/min. By counting the etching time, the etched bottom of the cavity 318 is controlled to stop at a 5 to 20 μm distance from the boundary of the first porous single crystal silicon well 303. As a result, a 5 to 20 μm thick thinned or remained layer 319 of the single crystal silicon substrate 301 appears on the bottom of the cavity 318.

In the eighth step, the thinned or remained layer 319 is removed by using selective dry etching. A used etchant can be chosen from SF₆ and SF₆/C₄F₈. SF₆ and SF₆/C₄F₈ cant etch the thinned or remained layer 319, but not the porous single crystal silicon well 303. This is due to the fact that the pore walls of the porous single crystal silicon surface is partially oxidized after the mild thermal treatment and slow removal of the oxide layer from the pore walls lowers the etch rate of SF₆ and SF₆/C₄F₈. The first porous single crystal silicon well 303 is then removed by immersing in a diluted HF solution and then etching in a 1 to 5% KOH solution or by etching in a 49% HF/30% H₂O₂(1:5) solution at room temperature, resulting in a laterally expanded cavity 320 and a 0.5 to 2 micron thick flexible plate 321, as shown in FIG. 10.

As an alternative, the remained substrate layer 319 can be removed by etching in a 126HNO₃:60H₂O:(5 to 20)NH₄F solution at room temperature. This solution etches single crystal silicon and porous single crystal silicon with a about same rate ranging from 0.15 to 0.5 μm/min. The etched front can be allowed to go into the first porous single crystal well 303 for 3 to 5 μm by counting the etch time. The thinned or remained layer of the porous single crystal silicon well 303 is then removed by etching in a 1 to 5% KOH solution or 49% HF/30% H₂O₂(1:5) solution at room temperature, resulting in the laterally expanded cavity 320 and the flexible plate 321. It is also needs to immerse in a diluted HF solution before etching in a 1 to 5% KOH solution.

In general, the eighth step is a final step for fabricating a single crystal silicon micromachined capacitive microphone introduced by the present invention. But for an integrated single crystal silicon micromachined capacitive microphone, in accordance with the present invention, an additional fabrication step is required.

As shown in FIG. 11, an integrated circuit, such a CMOS circuit 322 for conditioning the electronic signals generated by the microphone can be formed in the portion 311 of the second epitaxial single crystal silicon layer. This step can be conducted between step 4 and step 5 by using a standard CMOS technology. After completing the integrated circuit fabrication a HF resistant passivation layer 323 is used to cover the integrated circuit region. Amorphous silicon carbide, nitride on oxide, and undoped polysilicon on oxide can resist HF etching and therefore can be used as the passivation material.

The preferred versions or embodiments of the invention described in detail above are intended only to illustrate the invention. Those skilled in the art will recognize that modifications, additions and substitutions can be made in various features and elements without departing from the true scope and spirit of the invention. The following claims are intended to cover the true scope and spirit of the invention.

What is claimed is:

1. A single crystal silicon micromachined capacitive microphone comprising:
a single crystal silicon substrate,
an acoustic cavity recessed in the substrate,
a flexible single crystal silicon plate with the edge clamped to the inside of the substrate and the rear side facing the cavity,
a single crystal silicon contained supporting frame having the bottom surface joined with the top surface of the periphery of the flexible plate and the top surface coated with an insulating layer,
a stiff and perforated single crystal silicon plate with the bottom surface of the periphery which is joined with the top surface of the insulating layer of the supporting frame, an air gap sandwiched between the flexible plate and the stiff and perforated plate and surrounding by the supporting frame, and
two electrodes one of which is interconnected to the flexible plate and the other is interconnected to the stiff and perforated plate.

2. A single crystal silicon micromachined capacitive microphone as in claim 1, further comprises an integrated circuit for conditioning the electronic signals generated by the microphone, which is incorporated in the single crystal silicon substrate therewith.

3. A single crystal silicon micromachined capacitive microphone as in claim 1, wherein said flexible plate is made from the 0.5 to 2 micron thick thinned or bottom remained layer of a first epitaxial single crystal silicon layer grown on the surface of a first porous single crystal silicon well that is converted from a doped top layer of the single crystal silicon substrate.

4. A single crystal silicon micromachined capacitive microphone as in claim 1, wherein said supporting frame is made from a merged lateral overgrowth of the first epitaxial single crystal silicon layer grown on the edge surface of the insulating layer.

5. A single crystal silicon micromachined capacitive microphone as in claim 1, wherein said supporting frame is made from a combination of two side lateral overgrowths of the first epitaxial single crystal silicon layer grown on the edge surface of the insulating layer and a polysilicon layer deposited on the central surface of the insulating layer.

6. A single crystal silicon micromachined capacitive microphone as in claim 1, wherein said stiff and perforated plate is made from a 10 to 20 micron thick second epitaxial single crystal silicon layer grown on the surface of a second porous single crystal silicon well that is converted from the 2 to 4 micron thick doped top layer of the first epitaxial single crystal silicon layer.

7. A single crystal silicon micromachined capacitive microphone as in claim 1, wherein said air gap is formed by etching away the 2 to 4 micron thick second porous single crystal silicon well that is converted from the 2 to 4 micron thick doped top layer of the first epitaxial single crystal silicon layer.

8. A single crystal silicon micromachined capacitive microphone as in claim 1, wherein said flexible plate is released by selective etching of the first porous single crystal silicon well, which is converted from the doped top layer of the single crystal silicon substrate.

9. A single crystal silicon micromachined microphone as in claim 1, wherein said stiff and perforated plate is released by selective etching of the second porous single crystal silicon well, which is converted from the 2 to 4 micron thick doped top layer of the first epitaxial single crystal silicon layer.

10. A single crystal silicon micromachined capacitive microphone as in claim 1, wherein said cavity is created by selective etching of the single crystal silicon substrate, which can be stopped at/in the first porous single crystal silicon well that is converted from the doped top layer of the single crystal silicon substrate.

11. A method for fabricating a single crystal silicon micromachined capacitive microphone comprising steps of
preparing a single crystal silicon substrate,
forming a first porous single crystal silicon well in the top layer of the single crystal silicon substrate,
growing a first epitaxial single crystal silicon layer over the surface of the single crystal silicon substrate including the surface of the first porous single crystal silicon well,
forming a second porous single crystal silicon well in the top layer of the first epitaxial single crystal silicon layer, which is located above the first porous single crystal silicon well and has a thickness less than the thickness of the first epitaxial single crystal silicon layer so that a remained layer of the first epitaxial single crystal layer can be produced,
forming an insulating layer on the surface of a portion of the first epitaxial single crystal silicon layer, which encloses the second porous single crystal silicon well,
growing a second epitaxial single crystal silicon layer over the surface of the first epitaxial single crystal silicon layer including the surface of the second porous single crystal silicon well, at the same time depositing a polysilicon layer on the surface of the insulating layer,
creating a plurality of throughout holes in a portion of the second epitaxial single crystal silicon layer, which is located on the top surface of the second porous single crystal silicon well, at the same time creating two deep trenches, one of which encloses the insulating layer and the other encloses a portion of the second epitaxial single crystal silicon layer which is located the outside of the insulating layer,
forming two electrodes one of which is electrically interconnecting to the throughout holes contained portion of the second epitaxial single crystal silicon layer and the other is electrically interconnected down to the first epitaxial single crystal silicon layer,
etching the second porous single crystal silicon well through the throughout holes to form an air gap and a stiff and perforated plate,
etching backside of the silicon substrate so as to form a cavity whose bottom has a remained layer of the single crystal silicon substrate,
etching the remained layer of the single crystal silicon substrate, and
selectively etching the first porous single crystal silicon well to form a flexible plate.

12. A method for fabricating a single crystal silicon micromachined capacitive microphone, as in claim 11, further comprising a step of fabricating a CMOS circuit for conditioning the electronic signals generated by the microphone, which is made from a portion of the second epitaxial single crystal silicon layer, which is not grown from the second porous single crystal silicon well.

13. A method for fabricating a single crystal silicon capacitive micromachined microphone, as in claim 11, wherein said the top layer of the single crystal silicon substrate is doped to 10¹⁸ to 10¹⁹/cm³ in average concentration.

14. A method for fabricating a single crystal silicon capacitive micromachined microphone, as in claim 11, wherein said first porous single crystal silicon well has been treated in dry oxygen at 300 to 400° C. for 1 hour.

15. A method for fabricating a single crystal silicon capacitive micromachined microphone, as in claim 11, wherein said the top layer of the first epitaxial single crystal silicon layer is doped to 10¹⁸ to 10¹⁹/cm³ in average concentration.

16. A method for fabricating a single crystal silicon micromachined microphone, as in claim 11, wherein said cavity is created by etching in a KOH solution with a rate of about 1 micron/min.

17. A method for fabricating a single crystal silicon micromachined microphone, as in claim 11, wherein said thinned or remained layer of the single crystal silicon substrate is removed by wet etching in a 126HNO₃:60H₂O:(5-20)NH₄F solution with a rate of about 0.15 to 0.5 micro/min.

18. A method for fabricating a single crystal silicon micromachined microphone, as in claim 11, wherein said thinned or remained layer of the single crystal silicon substrate is removed by dry etching in gas SF₆ or SF₆/C₄F₈.

19. A method for fabricating a single crystal silicon micromachined microphone, as in claim 11, wherein said stiff and perforated plate has a thickness equal to the thickness of the second epitaxial single crystal silicon layer, which ranges from 10 to 20 microns.

20. A method for fabricating a single crystal silicon micromachined microphone, as in claim 11, wherein said flexible plate has a thickness equal to the thickness of the thinned or bottom remained layer of the first epitaxial single crystal silicon layer, which ranges from 0.5 to 2.0 microns.

21. A method for fabricating a single crystal silicon micromachined microphone, as in claim 11, wherein said air gap has a thickness equal to the thickness of the second porous single crystal silicon well, which ranges from 2 to 4 microns.
